(19) United States
(12) Patent Application Publication
(10) Pub. No.: US 2014/0339950 A1
(43) Pub. Date: Nov. 20, 2014

(54) Rotor Assembly with Electron Beam Welded End Caps

(71) Applicant: TESLA MOTORS, INC., Palo Alto, CA (US)

(72) Inventors: David Fred Nelson, Menlo Park, CA (US); Shyi-Perng Phillip Luan, Walnut Creek, CA (US); Edwin Marcum Pearce, JR., San Francisco, CA (US); William Randall Fong, Hayward, CA (US)

(73) Assignee: Tesla Motors, Inc., Palo Alto, CA (US)

(21) Appl. No.: 13/897,370

(22) Filed: May 18, 2013

(51) Int. Cl. H02K 17/16

(52) U.S. Cl. CPC H02K 17/16
USPC 310/211

(57) ABSTRACT

A rotor assembly and a method for fabricating the same are provided in which a pair of end caps, positioned at either end of the stack of laminated discs, are fusion welded to the rotor bars using an electron beam welder, thereby yielding improved electrical and mechanical characteristics in a low weight assembly.

### FIELD OF THE INVENTION

The present invention relates generally to electric motors and, more specifically, to an electric motor rotor assembly.

### BACKGROUND OF THE INVENTION

AC induction motors are widely used in a variety of industrial and residential applications. In general, this type of motor includes a laminated magnetic core mounted to a drive shaft. The laminated magnetic core may be fabricated from a plurality of laminated magnetic discs, or from a plurality of arc-like core segments. The laminated magnetic core includes a plurality of longitudinal slots into which bars of electrically conductive metal are fit. The ends of the bars extend beyond either end of the laminated magnetic core. An end-ring or end cap at either end of the laminated magnetic core is used to mechanically and electrically join the ends of the rotor bars.

It will be appreciated that there are numerous techniques that may be used to fabricate the rotor assembly in general and the cap assembly in particular. Typically these techniques make trade-offs between several, often competing, factors that include (i) maximizing the electrical conductivity between the rotor bars; (ii) rotor weight; (iii) material cost; and (iv) fabrication/assembly cost and complexity. One approach that has been used to fabricate the rotor assembly is disclosed in U.S. Pat. No. 3,778,652. As described, a casting process is used to cast aluminum conductor bars in the slots within the laminated magnetic core. To improve the fit between the cast bars and the slots of the core, this patent discloses utilizing projections within the slots, thereby confining and minimizing the shrinkage of the cast bars to small regions. The casting process can be used to cast both the conductor bars and the end rings that electrically couple the bars together.

U.S. Pat. No. 4,064,410 discloses an alternate rotor fabrication process. As disclosed, rotor bars are first inserted into a laminated core such that end portions of each bar protrude beyond the end laminations at either end of the core. An end ring is then positioned over the shaft at either end of the core, the end rings having a plurality of channels on the inner ring surface that are designed to accept the ends of the rotor bars. Welding is then used to fuse the end portions of the rotor bars to the end rings, the welding process being carried out while applying an axial compression of the two rings toward one another.

U.S. Pat. No. 6,088,906 discloses several techniques for forming a joint between the rotor bars that extend beyond the laminated core and the end rings positioned at either end of the rotor assembly. In one of the disclosed techniques, the end rings are rotated about their rotational axes at high speed, and then simultaneously pushed into contact with the ends of the rotor bars. Frictional heating causes the ends of the rotor bars to fuse into the complementary surfaces of the rings. This frictional heating approach may be augmented by applying a high axial current to the end rings. Also disclosed is a technique in which a pulsed current generator is used to heat a foil of a brazing alloy to form a braze joint between the end rings and the ends of the rotor bars.

Japanese Patent Application No. 2003020929 (Publication No. 2004007949) discloses a rotor fabrication technique in which the end rings are formed of multiple, individual arc-like end ring pieces. The end ring pieces are positioned at the ends of the laminated core, between the rotor bars. A rotary tool is used to friction weld the end surfaces of the rotor bars to the end ring pieces.

Co-assigned U.S. Pat. No. 8,365,392 discloses a method of fabricating a rotor assembly in which a solid ring is formed at either end of the stack of laminated discs, the solid rotor rings yielding improved electrical and mechanical characteristics in a low weight assembly. The solid rings are fabricated by brazing slugs between the end portions of the rotor bars, the brazing preferably being performed in a vacuum furnace or an induction brazing system.

While the prior art discloses a number of techniques that may be used to fabricate the rotor assembly of an electric motor, a simplified, reliable and cost effective fabrication technique that achieves high performance is desired. The present invention provides such a rotor assembly and fabrication process.

### SUMMARY OF THE INVENTION

A method of fabricating a rotor assembly is provided, the method including the steps of (i) inserting a plurality of rotor bars into a corresponding plurality of slots within a stack of laminated discs, where a first portion of each of the plurality of rotor bars protrudes from a first end surface of the stack of laminated discs, and where a second portion of each of the plurality of rotor bars protrudes from a second end surface of the stack of laminated discs; (ii) mounting a first end cap to the plurality of rotor bars, where the first portion of each of the plurality of rotor bars fits within a corresponding slot of a plurality of slots in the first end cap; (iii) mounting a second end cap to the plurality of rotor bars, where the second portion of each of the plurality of rotor bars fits within a corresponding slot of a plurality of slots in the second end cap; (iv) directing a first electron beam towards a circumferential side surface of the first end cap and fusing at least a region of the first portion of each of the plurality of rotor bars to the corresponding slot of the plurality of slots of the first end cap; and (v) directing a second electron beam towards a circumferential side surface of the second end cap and fusing at least a region of the second portion of each of the plurality of rotor bars to the corresponding slot of the plurality of slots of the second end cap. The first and second electron beams may be emitted by a pair of e-beam welders, thereby allowing the first and second end caps to be welded in a simultaneous operation, or by a single e-beam welder used to sequentially weld the first and second end caps. The first electron beam may be rotated about the first end cap and the second electron beam may be rotated about the second end cap during the fusing steps; alternately, the first end cap and rotor stack may rotate relative to the first electron beam and the second end cap and rotor stack may rotate relative to the second electron beam during the fusing steps. The first electron beam may be directed at the juncture defined by the outermost surface of the first portion of each of the plurality of rotor bars and the innermost seating surface of the corresponding slot of the plurality of slots of the first end cap, and the second electron beam may be directed at the juncture defined by the outermost surface of the second portion of each of the plurality of rotor bars and the innermost seating surface of the corresponding slot of the plurality of slots of the second end cap. The step of fusing at least a region of the first portion of each of the plurality of rotor bars to the corresponding slot of the plurality of slots of the first end cap may include the step of fusing to a first weld depth that extends beyond the inner radius defined by the plurality of rotor bars, and the step of fusing at least a region of the second portion of each of the plurality of rotor bars to the corresponding slot of the plurality of slots of the second end cap may include the step of fusing to a second weld depth that extends beyond the inner radius defined by the plurality of rotor bars. The method may further include (i) machining the first end cap to remove a first circumferential edge portion of the first end cap and an edge section of the region of the first portion of each of the plurality of rotor bars, where the step of machining the first end cap is performed after the step of directing the first electron beam towards the first end cap and (ii) machining the second end cap to remove a second circumferential edge portion of the second end cap and an edge section of the region of the second portion of each of the plurality of rotor bars, where the step of machining the second end cap is performed after the step of directing the second electron beam towards the second end cap. The method may further include fitting a first containment ring over the first end cap and fitting a second containment ring over the second end cap. The plurality of rotor bars and the first and second end caps may be fabricated from copper. The first and second end caps may be fabricated from copper using a forging process. The method may further include (i) pressing the first end cap onto the first portion of the plurality of rotor bars and towards the stack of laminated discs, and (ii) pressing the second end cap onto the second portion of the plurality of rotor bars and towards the stack of laminated discs. The method may further include (i) pressing the first end cap onto the first portion of the plurality of rotor bars and seating an inner surface of the first end cap onto a first outer disc of the stack of laminated discs, and (ii) pressing the second end cap onto the second portion of the plurality of rotor bars and seating an inner surface of the second end cap onto a second outer disc of the stack of laminated discs. The plurality of slots in the first end cap may pass through an inner surface of the first end cap and extend only partially through the first end cap towards an outer surface of the first end cap, and the plurality of slots in the second end cap may pass through an inner surface of the second end cap and extend only partially through the second end cap towards an outer surface of the second end cap.

In another aspect of the invention, an electric motor rotor assembly is provided, the assembly including (i) a rotor shaft; (ii) a plurality of laminated discs formed into a stack, where each laminated disc has a plurality of slots, the slots being co-aligned within the stack; (iii) a plurality of rotor bars passing through the slots within the stack where a first portion of the rotor bars extend out and away from a first end surface of the stack and where a second portion of the rotor bars extend out and away from a second end surface of the stack; (iv) a first end cap fused to the plurality of rotor bars, where the first end cap is comprised of a first plurality of slots, where the first portion of each of the plurality of rotor bars fits within a corresponding slot of the first plurality of slots, where a first end region corresponding to the first portion of each of the plurality of rotor bars is fusion welded via an electron beam to the corresponding slot of the first plurality of slots of the first end cap, and where the first end region extends from an outer rotor bar radius defined by the plurality of rotor bars to an inner rotor bar radius defined by the plurality of rotor bars; and (v) a second end cap fused to the plurality of rotor bars, where the second end cap is comprised of a second plurality of slots, where the second portion of each of the plurality of rotor bars fits within a corresponding slot of the second plurality of slots, where a second end region corresponding to the second portion of each of the plurality of rotor bars is fusion welded via the electron beam to the corresponding slot of the second plurality of slots of the second end cap, and where the second end region extends from the outer rotor bar radius defined by the plurality of rotor bars to the inner rotor bar radius defined by the plurality of rotor bars. The assembly may further include first and second containment rings positioned around the first/second end caps and the first/second rotor bar portions, for example over circumferential edge portions of the first/second end caps that have been machined. The rotor bars and first/second end caps may be comprised of copper. The first and second end caps may be forged, for example using a closed die forging press.

A further understanding of the nature and advantages of the present invention may be realized by reference to the remaining portions of the specification and the drawings.

### BRIEF DESCRIPTION OF THE DRAWINGS

FIG. 1 provides a perspective view of the primary components of a rotor assembly, shown in an exploded relation, in accordance with a preferred embodiment of the invention;

FIG. 2 is an illustration of a laminated disc used in the laminated disc assembly;

FIG. 3 is a detailed view of three of the slots of the laminated disc shown in FIG. 2;

FIG. 4 is a cross-sectional view of a rotor bar suitable for use with the laminated disc shown in FIG. 2 and the rotor stack of FIG. 1;

FIG. 5 provides a side view of the rotor core assembly after insertion of the rotor bars into the stack of laminated discs;

FIG. 6 provides a perspective, exploded view of the core assembly and end caps;

FIG. 7 provides a perspective view of one of the end caps, this view showing the slots into which the ends of the rotor bars are inserted;

FIG. 8 provides a side view of the end cap shown in FIG. 7;

FIG. 9 provides a perspective view of the end cap and lamination stack prior to assembly;

FIG. 10 provides a perspective view of the end cap and lamination stack shown in FIG. 9 taken from a different angle;

FIG. 11 illustrates the step of seating the end caps onto the core assembly;

FIG. 12 illustrates the e-beam end cap welding step;

FIG. 13 illustrates the desired weld depth during the e-beam welding step;

FIG. 14 illustrates the rotor assembly prior to installation of the containment rings; and

FIG. 15 illustrates the rotor assembly post-installation of the containment rings.

### DESCRIPTION OF THE SPECIFIC EMBODIMENTS

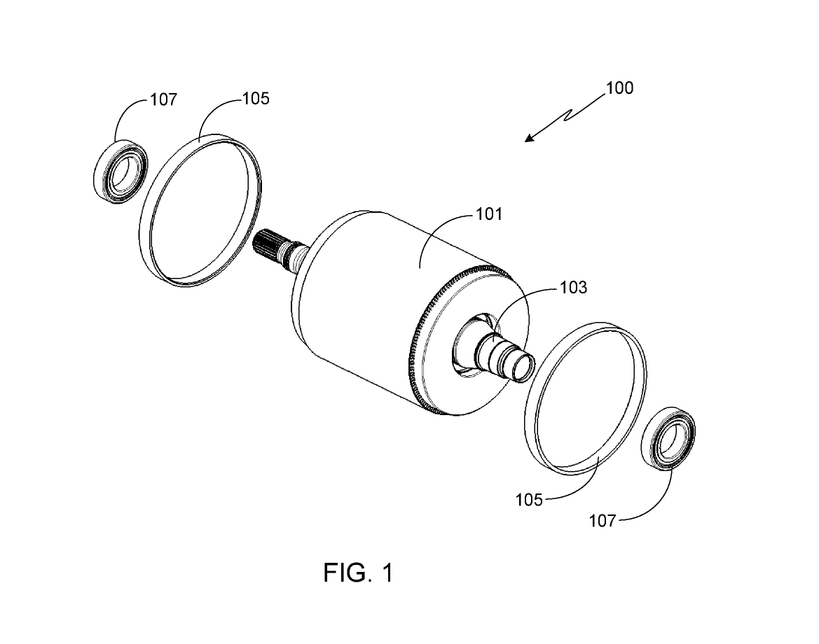

FIG. 1 is a partially exploded, perspective view of the primary components of a rotor assembly 100 in accordance with a preferred embodiment of the invention. It will be appreciated that other configurations may be used with the invention, and the specific designs and dimensions provided relative to the preferred embodiment are only meant to illustrate, not limit, the scope of the invention and should not be considered to be to scale. Additionally, it should be understood that identical element symbols used on multiple figures refer to the same component, or components of equal functionality.

As described in further detail below, the core assembly 101 is comprised of a plurality of laminated discs, typically referred to as the rotor stack, and a plurality of conductor bars, also referred to herein as rotor bars. Core assembly 101 is coaxially mounted to a rotor shaft 103, shown already inserted into assembly 101 in this figure. Shaft 103 may include keys or similar means to locate and position the core assembly about its central axis, although in the preferred embodiment shaft 103 is press-fit into the core assembly 101 which is preferably held at an elevated temperature during the press-fitting operation. At either end of core assembly 101 is a rotor containment ring 105. Additionally, rotor assembly 100 includes ball bearing assemblies 107 as shown in FIG. 1, as well as various washers, seals, and retaining rings that are not shown.

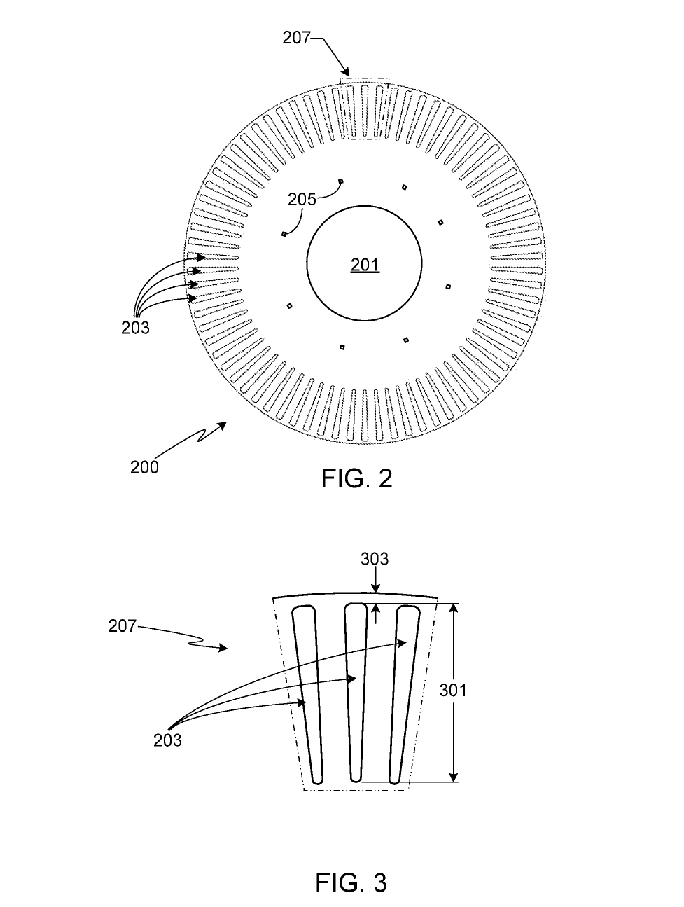

FIG. 2 illustrates a single laminated steel disc 200. It will be appreciated that the invention may utilize laminated discs of a different size, with a different number of slots, and with a differently shaped slot design without departing from the invention. A stack of discs 200 form the stack comprising core assembly 101. In the preferred embodiment, approximately 400 discs 200, each approximately 0.35 millimeters thick, comprise core assembly 101. The center 201 of each disc is removed, for example utilizing a boring or stamping procedure, center 201 sized to fit rotor shaft 103. As shown, each disc 200 includes a plurality of slots 203, slots 203 having substantially the same shape. In the illustrated embodiment, disc 200 includes 74 equally spaced slots 203. To insure that during assembly slots 203 are aligned throughout the entire stack of laminated discs, preferably half shears 205 are included on each disc 200. It will be appreciated that the exact configuration, i.e., the number, location and shape of the half shears, is unimportant as long as a means is provided to insure that the slots in all of the discs are aligned.

A detailed view 207 of three slots 203 is provided in FIG. 3. Slots 203 are generally rectangular in shape. In the preferred embodiment, and as illustrated, each slot 203 has a slot height 301 of approximately 20. The outermost edge of slot 203 is preferably less than 5 millimeters from the outer edge of disc 200 (i.e., spacing 303). Preferably the lowermost edge of slot 203 has a radius of curvature of less than 1 millimeter.

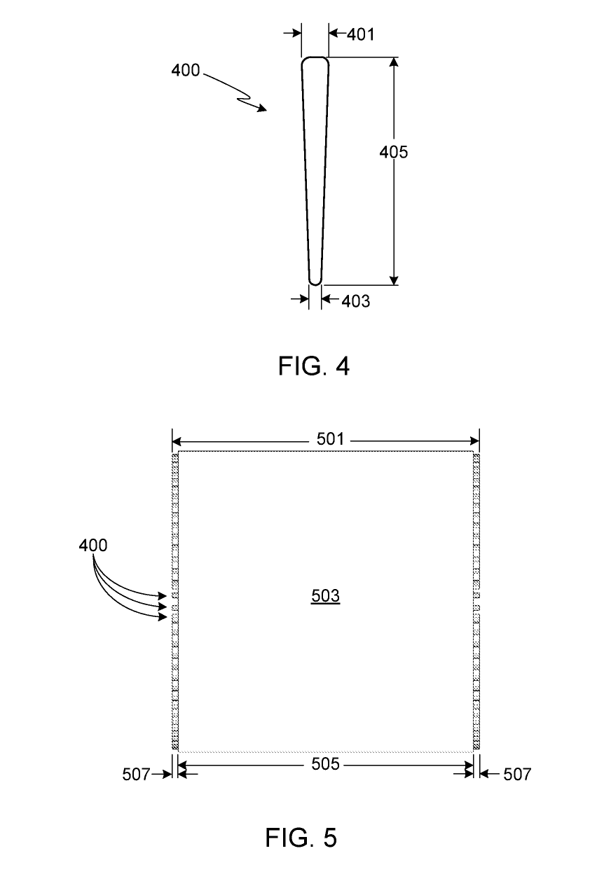

Core assembly 101 is further comprised of a plurality of rotor bars, the number of rotor bars being equivalent to the number of slots 203 (e.g., 74 in the preferred embodiment). Preferably the rotor bars are extruded from oxygen free copper. FIG. 4 provides a cross-sectional view of a rotor bar 400. The rotor bars have substantially the same shape as slots 203, although the dimensions are slightly smaller in order to allow bars 400 to be inserted into slots 203. In the illustrated embodiment, each bar 400 has an upper width 401 of approximately 3 millimeters, a lower width 403 of approximately 1 millimeter, a height 405 slightly less than slot height 301 and a length 501 of less than 175 millimeters. As shown in FIG. 5, preferably the lamination stack 503 has an overall length 505 such that each rotor bar 400 extends out either end of the laminated stack 503 by approximately 3 millimeters (i.e., dimensions 507).

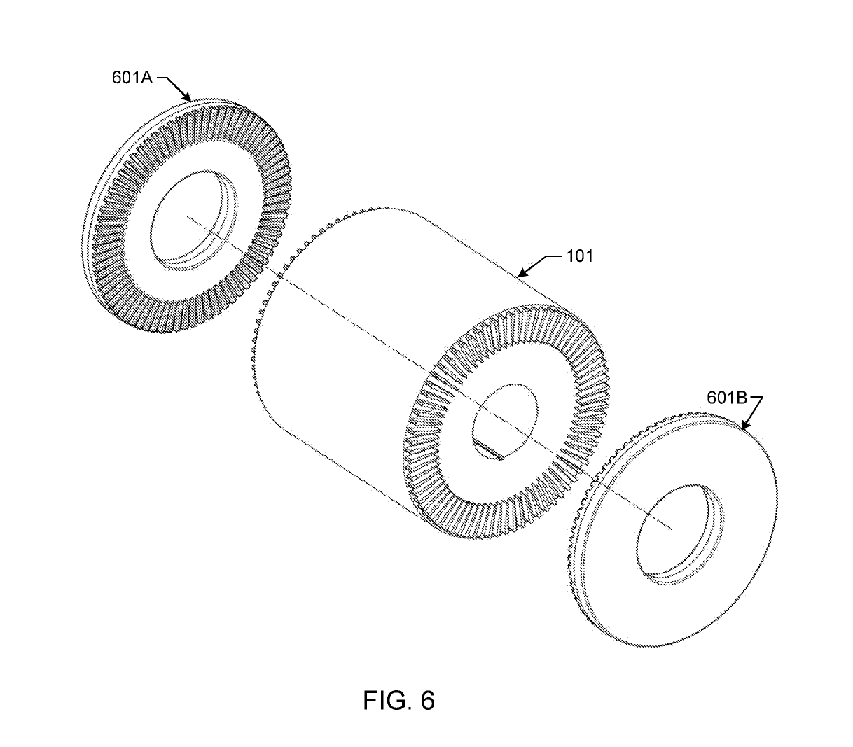

After assembly of the stack of laminated discs 503 and the insertion of rotor bars 400 into slots 203, the end assemblies are fabricated. As shown in the perspective, exploded view of FIG. 6, on either end of the core assembly 101 is an end cap 601 (represented as 601A and 601B in FIG. 6). The end caps are preferably forged, and more preferably forged with a closed die forging press. As the end caps are preferably forged, rather than cast, high purity copper can be used. Additionally, due to the forging process, the porosity associated with casting can be eliminated, thereby achieving higher electrical conductivity which, in turn, leads to improved motor efficiency and power.

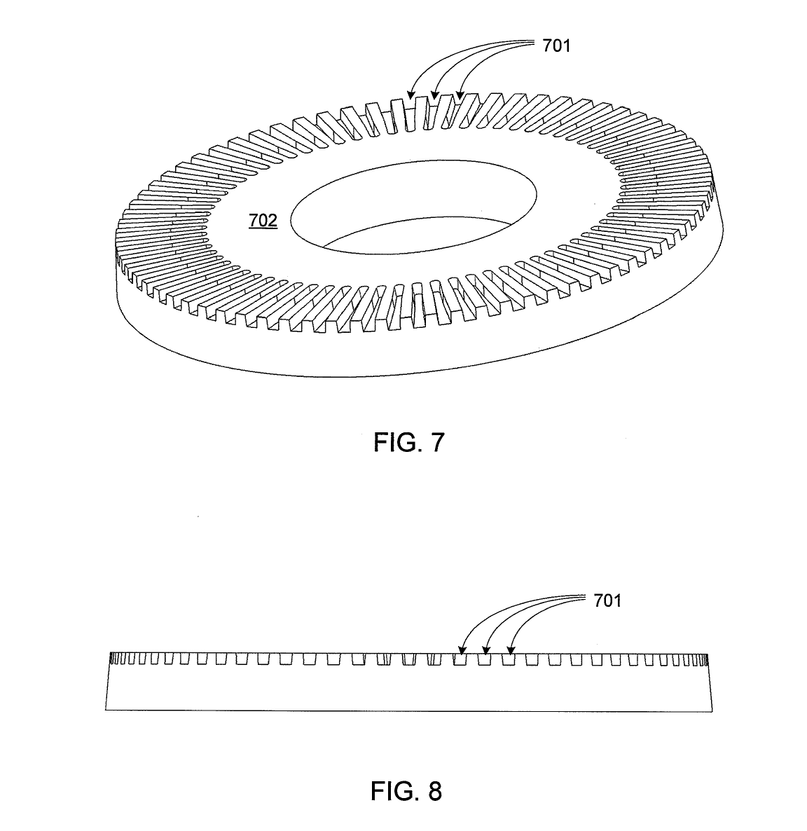

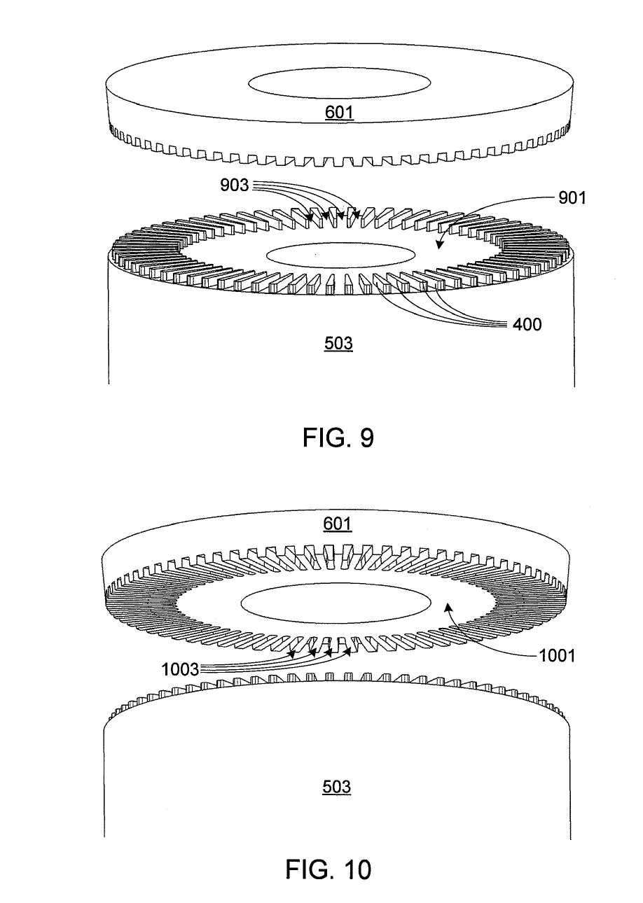

FIGS. 7 and 8 provided perspective and side views, respectively, of one of the end caps 601. For each end cap 601, the surface 702 that faces the core assembly 101 includes a plurality of slots 701, the number of slots 701 being equivalent to the number of rotor bars 400 protruding from slots 203 (e.g., 74 in the preferred embodiment). Slots 701, also referred to herein as cavities, extend partially through the end cap and are shaped and sized to accommodate the protruding ends of rotor bars 400. In the preferred embodiment each slot 701 extends approximately 3 millimeters into the end cap, thereby simplifying the forging process. FIGS. 9 and 10 provide two different views taken at two different angles of the same region of an exemplary laminate stack and end cap prior to assembly. Once assembled, surface 1001 of end cap 601 seats on surface 901 of lamination stack 503. Similarly, each region 903 of the lamination stack 503 that is located between the protruding ends of rotor bars 400 will seat on complimentary end cap surfaces 1003 after assembly of the end caps to the core assembly.

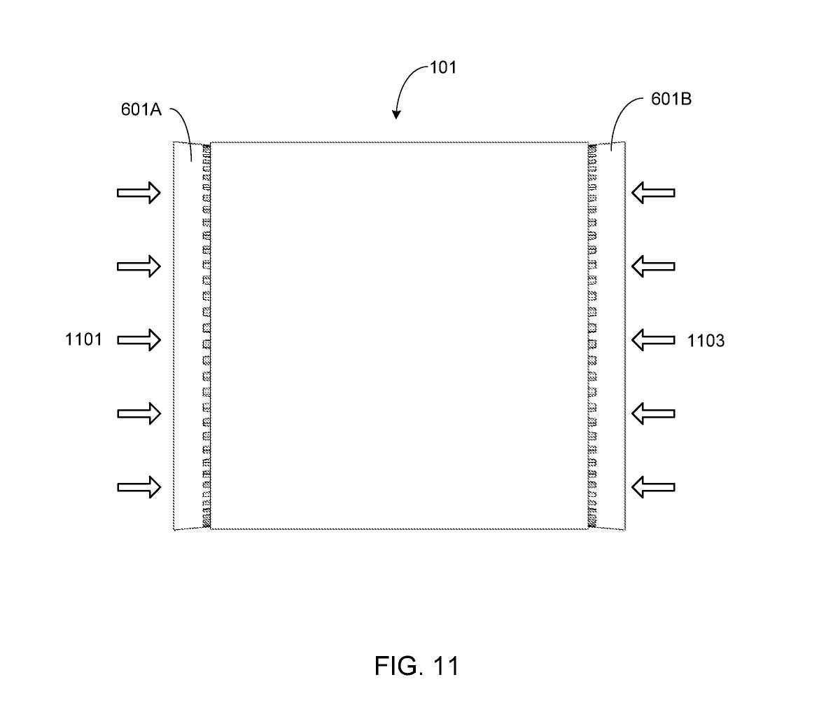

In order to obtain the desired level of rotor performance and that none of the rotor bars experience a spike in energy density, it is important that each end cap 601 is fully seated on the core assembly 101 and that the end of each rotor bar 400 is fully seated within the corresponding end cap slot 701. To achieve this goal, after the end caps 601 are assembled onto the core assembly a force is applied to the end caps, pressing them firmly onto the core assembly. This fabrication step is illustrated in FIG. 11, the figure showing force being applied in directions 1101 and 1103. Note that due to the malleability of copper, the material used for both the rotor bars 400 and the end caps 601 in the preferred embodiment, it is relatively easy to seat the end caps during this compression step and achieve full contact both between the complementary seating surfaces and the rotor bars 400 and the corresponding slots 203.

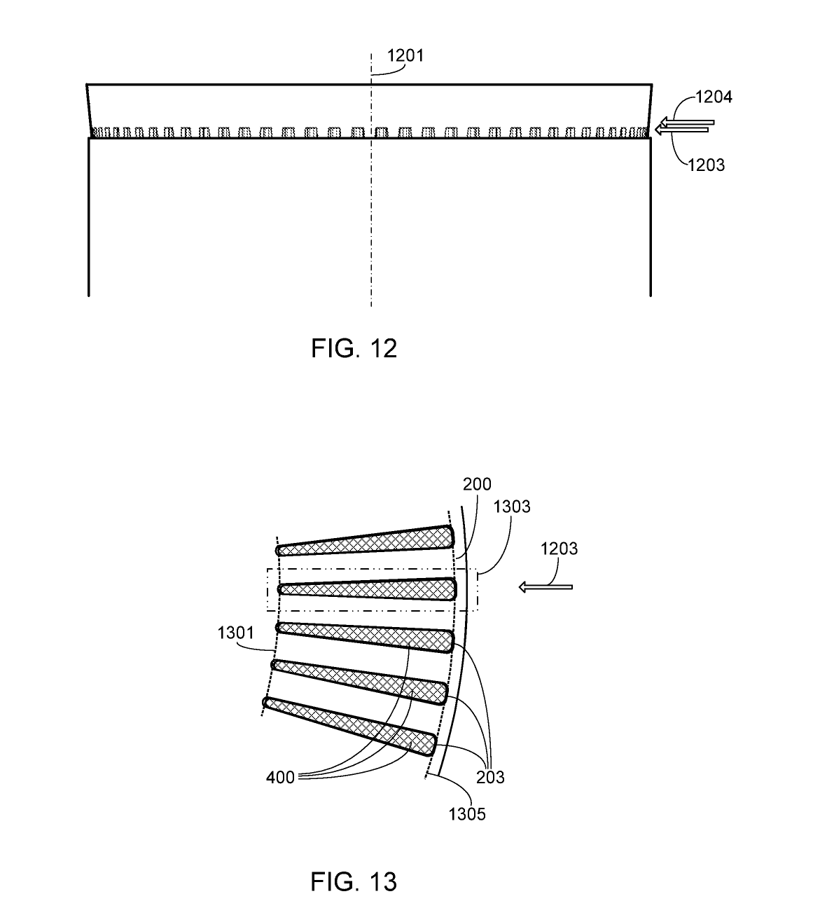

Once the end caps have been seated onto the core assembly, an electron-beam (i.e., e-beam) welder is used to fusion weld each end cap to the rotor bars 400. The e-beam is directed toward the circumferential side surface of each end cap, preferably towards the rotor assembly's central axis 1201 in a direction 1203 as shown in FIG. 12. A single e-beam welder may be used to sequentially fuse the rotor bars to the end caps; alternately, two different e-beam welders may be used, thereby allowing simultaneous end cap welding. In at least one embodiment, the e-beam is directed at the juncture of the outermost end surface of each rotor bar 400 and the innermost seating surface of each end cap slot 701. In at least one alternate embodiment, the e-beam is offset from this juncture in the direction of the end cap (represented by e-beam direction 1204). Although it is easiest to rotate the rotor assembly about axis 1201 during the welding operation, it will be appreciated that it is also possible to rotate the e-beam around the rotor assembly. In order to achieve the desired performance, the weld depth must extend past the entire rotor bar, i.e., dimension 405 shown in FIG. 4. This aspect of the invention is illustrated in FIG. 13 which shows a portion of disc 200, this portion including five slots 203. Within each slot is a rotor bar 400. As noted above, in the preferred embodiment the weld depth extends beyond the inner radius 1301 of rotor bars 400. The typical weld zone, represented in FIG. 13 by zone 1303, extends 1-5 millimeters, and more preferably 2-3 millimeters, beyond the inner edge (i.e., the inner bar radius) of rotor bars 400. It should be understood that weld zone 1303 represents the weld zone for a single bar and as such, must be repeated for each rotor bar. Therefore in the exemplary embodiment, this weld zone would be repeated 74 times.

After each end cap 601 has been e-beam welded to the rotor bars, the shaft 103 is installed in the welded core assembly 101. While those of skill in the art will recognize that there are numerous techniques for installing the shaft, in the preferred embodiment shaft 103 is press-fit into the core assembly 101 as previously described. Once the rotor shaft is installed, the assembly is balanced. Typically balancing is performed by turning the rotor assembly on a lathe and removing a circumferential outer portion of each end cap. During this step a portion of the outer radius of the end portion of the rotor bars is typically removed as well. The outer radius 1305 of the rotor bars, prior to removal of any material, is shown in FIG. 13. During the balancing step, imperfections due to the forging and welding steps can be removed. This step also insures concentricity with the rotor shaft. It should be understood that although machining of the assembly is preferably performed using a lathe, other means may be used (e.g., a mill, grinder, sander, etc.).

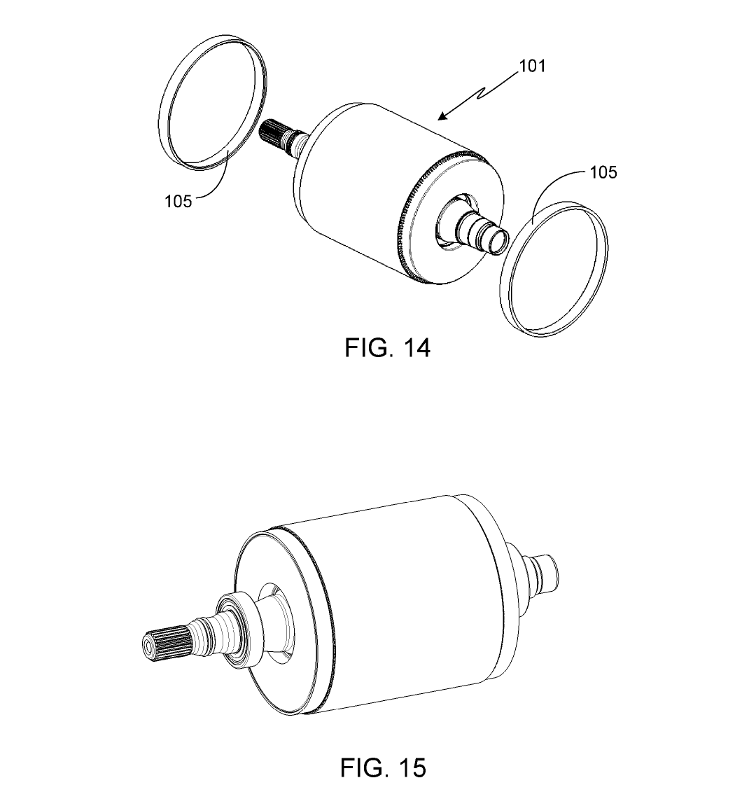

Once the machining step is completed, thereby removing a portion of the end caps, rotor containments rings 105 are positioned over the ends of the assembly. FIGS. 14 and 15 show pre- and post-installation, respectively, of the containment rings. Preferably the rotor containment rings are fabricated from stainless steel, although other materials may be used (e.g., beryllium-copper alloys, etc.). Rotor containment rings 105 may be press-fit over the rotor bar/end cap assemblies. Note that the rotor containment rings may also be soldered, bonded, or welded in place. Additionally, temperature differentials (i.e., containment ring heating and/or assembly cooling) may be used to simplify assembly and/or achieve the desired interference fit.

The remaining portions of the rotor assembly 100 can be finished using conventional rotor components with the finished rotor being used to build a conventional electric motor using conventional techniques.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A method of fabricating a rotor assembly for an electric motor, the method comprising:
inserting a plurality of rotor bars into a corresponding plurality of slots within a stack of laminated discs, wherein a first portion of each of said plurality of rotor bars protrudes from a first end surface of said stack of laminated discs, and wherein a second portion of each of said plurality of rotor bars protrudes from a second end surface of said stack of laminated discs;
mounting a first end cap to said plurality of rotor bars, wherein said first portion of each of said plurality of rotor bars fits within a corresponding slot of a first plurality of slots in said first end cap;
mounting a second end cap to said plurality of rotor bars, wherein said second portion of each of said plurality of rotor bars fits within a corresponding slot of a second plurality of slots in said second end cap;
directing a first electron beam towards a circumferential side surface of said first end cap and fusing at least a region of said first portion of each of said plurality of rotor bars to said corresponding slot of said first plurality of slots of said first end cap; and
directing a second electron beam towards a circumferential side surface of said second end cap and fusing at least a region of said second portion of each of said plurality of rotor bars to said corresponding slot of said second plurality of slots of said second end cap.

2. The method of claim 1, wherein said first electron beam and said second electron beam are emitted by a single e-beam welder, and wherein said steps of directing said first electron beam and directing said second electron beam are performed sequentially.

3. The method of claim 1, wherein said first electron beam is emitted by a first e-beam welder and said second electron beam is emitted by a second e-beam welder, and wherein said steps of directing said first electron beam and directing said second electron beam are performed simultaneously.

4. The method of claim 1, wherein said step of directing said first electron beam further comprises the step of rotating said first electron beam about said first end cap such that said first electron beam sequentially fuses at least said region of said first portion of each of said plurality of rotor bars to said corresponding slot of said first plurality of slots of said first end cap, and wherein said step of directing said second electron beam further comprises the step of rotating said second electron beam about said second end cap such that said second electron beam sequentially fuses at least said region of said second portion of each of said plurality of rotor bars to said corresponding slot of said second plurality of slots of said second end cap.

5. The method of claim 1, wherein after performing said step of mounting said first end cap and while performing said step of directing said first electron beam said method further comprises the step of rotating said first end cap and said stack of laminated discs relative to said first electron beam such that said first electron beam sequentially fuses at least said region of said first portion of each of said plurality of rotor bars to said corresponding slot of said first plurality of slots of said first end cap, and wherein after performing said step of mounting said second end cap and while performing said step of directing said second electron beam said method further comprises the step of rotating said second end cap and said stack of laminated discs relative to said second electron beam such that said second electron beam sequentially fuses at least said region of said second portion of each of said plurality of rotor bars to said corresponding slot of said second plurality of slots of said second end cap.

6. The method of claim 1, wherein said step of directing said first electron beam further comprises the step of directing said first electron beam at a first juncture defined by an outermost surface of said first portion of each of said plurality of rotor bars and an innermost seating surface of said corresponding slot of said first plurality of slots of said first end cap, and wherein said step of directing said second electron beam further comprises the step of directing said second electron beam at a second juncture defined by an outermost surface of said second portion of each of said plurality of rotor bars and an innermost seating surface of said corresponding slot of said second plurality of slots of said second end cap.

7. The method of claim 1, wherein said step of directing said first electron beam further comprises the step of directing said first electron beam at a first location offset from a first juncture defined by an outermost surface of said first portion of each of said plurality of rotor bars and an innermost seating surface of said corresponding slot of said first plurality of slots of said first end cap, wherein said first location is offset from said first juncture away from said stack of laminated discs and towards said first end cap, wherein said step of directing said second electron beam further comprises the step of directing said second electron beam at a second location offset from a second juncture defined by an outermost surface of said second portion of each of said plurality of rotor bars and an innermost seating surface of said corresponding slot of said second plurality of slots of said second end cap, and wherein said second location is offset from said second juncture away from said stack of laminated discs and towards said second end cap.

8. The method of claim 1, wherein said step of fusing at least said region of said first portion of each of said plurality of rotor bars to said corresponding slot of said first plurality of slots of said first end cap further comprises the step of fusing to a first weld depth, wherein said first weld depth extends beyond an inner radius defined by said plurality of rotor bars, and wherein said step of fusing at least said region of said second portion of each of said plurality of rotor bars to said corresponding slot of said second plurality of slots of said second end cap further comprises the step of fusing to a second weld depth, wherein said second weld depth extends beyond said inner radius defined by said plurality of rotor bars.

9. The method of claim 1, further comprising:
machining said first end cap to remove a first circumferential edge portion of said first end cap and an edge section of said region of said first portion of each of said plurality of rotor bars, wherein said step of machining said first end cap is performed after said step of directing said first electron beam; and
machining said second end cap to remove a second circumferential edge portion of said second end cap and an edge section of said region of said second portion of each of said plurality of rotor bars, wherein said step of machining said second end cap is performed after said step of directing said second electron beam.

10. The method of claim 9, further comprising the steps of:
fitting a first containment ring over said first end cap, wherein said first containment ring is positioned on said first end cap at a location corresponding to said outermost end region of said first end cap where said first circumferential edge portion was removed via said step of machining said first end cap; and
fitting a second containment ring over said second end cap, wherein said second containment ring is positioned on said second end cap at a location corresponding to said outermost end region of said second end cap where said second circumferential edge portion was removed via said step of machining said second end cap.

11. The method of claim 1, further comprising the steps of:
fabricating said plurality of rotor bars from a copper material;
fabricating said first end cap from said copper material; and
fabricating said second end cap from said copper material.

12. The method of claim 1, further comprising the steps of forging said first end cap from copper and forging said second end cap from copper.

13. The method of claim 1, further comprising the steps of pressing said first end cap onto said first portion of said plurality of rotor bars and towards said stack of laminated discs, and pressing said second end cap onto said second portion of said plurality of rotor bars and towards said stack of laminated discs.

14. The method of claim 13, wherein said step of pressing said first end cap onto said first portion of said plurality of rotor bars further comprises the step of seating an inner surface of said first end cap onto a first outer disc of said stack of laminated discs, and wherein said step of pressing said second end cap onto said second portion of said plurality of rotor bars further comprises the step of seating an inner surface of said second end cap onto a second outer disc of said stack of laminated discs.

15. The method of claim 1, wherein said first plurality of slots pass through an inner surface of said first end cap and extend only partially through said first end cap towards an outer surface of said first end cap, and wherein said second plurality of slots pass through an inner surface of said second end cap and extend only partially through said second end cap towards an outer surface of said second end cap.

16. A rotor assembly for an electric motor, comprising:
a rotor shaft;
a plurality of laminated discs formed into a stack of laminated discs, wherein each of said plurality of laminated discs includes a plurality of slots, wherein said plurality of slots of each of said plurality of laminated discs are co-aligned within said stack of laminated discs, and wherein said stack of laminated discs is mounted to said rotor shaft;
a plurality of rotor bars passing through said plurality of slots of said stack of laminated discs, wherein a first portion of each of said plurality of rotor bars extends out and away from a first end surface of said stack of laminated discs, and wherein a second portion of each of said plurality of rotor bars extends out and away from a second end surface of said stack of laminated disc;
a first end cap fused to said plurality of rotor bars, wherein said first end cap is comprised of a first plurality of slots, wherein said first portion of each of said plurality of rotor bars fits within a corresponding slot of said first plurality of slots, wherein a first end region corresponding to said first portion of each of said plurality of rotor bars is fusion welded via an electron beam to said corresponding slot of said first plurality of slots of said first end cap, and wherein said first end region extends from an outer rotor bar radius defined by said plurality of rotor bars to an inner rotor bar radius defined by said plurality of rotor bars; and
a second end cap fused to said plurality of rotor bars, wherein said second end cap is comprised of a second plurality of slots, wherein said second portion of each of said plurality of rotor bars fits within a corresponding slot of said second plurality of slots, wherein a second end region corresponding to said second portion of each of said plurality of rotor bars is fusion welded via said electron beam to said corresponding slot of said second plurality of slots of said second end cap, and wherein said second end region extends from said outer rotor bar radius defined by said plurality of rotor bars to said inner rotor bar radius defined by said plurality of rotor bars.

17. The rotor assembly of claim 16, further comprising:
a first containment ring positioned around a section of said first end cap and said first portion of each of said plurality of rotor bars; and
a second containment ring positioned around a section of said second end cap and said second portion of each of said plurality of rotor bars.

18. The rotor assembly of claim 17, wherein a first circumferential edge portion corresponding to said first end cap and an edge section of said first portion of each of said plurality of rotor bars is machined prior to positioning said first containment ring, and wherein a second circumferential edge portion corresponding to said second end cap and an edge section of said second portion of each of said plurality of rotor bars is machined prior to positioning said second containment ring.

19. The rotor assembly of claim 16, wherein said plurality of rotor bars are comprised of copper, wherein said first end cap is comprised of copper, and wherein said second end cap is comprised of copper.

20. The rotor assembly of claim 16, wherein said first and second end caps are forged.
